(19) United States
(12) Patent Application Publication
(10) Pub. No.: US 2009/0300629 A1
(43) Pub. Date: Dec. 3, 2009

(54) Scheduling of Multiple Tasks in a System Including Multiple Computing Elements

(76) Inventors: Mois Navon, Efrat (IL); Elchanan Rushinek, Newe-Yaraq (IL); Emmanuel Sixou, Jerusalem (IL); Arkady Pann, Mazkoret Batya (IL); Yossi Kreinin, Jerusalem (IL)

Correspondence Address: The Law Office of Michael E. Kondoudis, 888 16th Street, N.W., Suite 800, Washington, DC, 20006, US

(21) Appl. No.: 12/131,173

(22) Filed: Jun. 2, 2008

(51) Int. Cl. G06F 9/44

(52) U.S. Cl. 718/102

(57) ABSTRACT

A method for controlling parallel process flow in a system including a central processing unit (CPU) attached to and accessing system memory, and multiple computing elements. The computing elements (CEs) each include a computational core, local memory and a local direct memory access (DMA) unit. The CPU stores in the system memory multiple task queues in a one-to-one correspondence with the computing elements. Each task queue, which includes multiple task descriptors, specifies a sequence of tasks for execution by the corresponding computing element. Upon programming the computing element with task queue information of the task queue, the task descriptors of the task queue in system memory are accessed. The task descriptors of the task queue are stored in the local memory of the computing element. The accessing and the storing of the data by the CEs is performed using the local DMA unit. When the tasks of the task queue are executed by the computing element, the execution is typically performed in parallel by at least two of the computing elements. The CPU is interrupted respectively by the computing elements only upon their fully executing the tasks of their respective task queues.

### FIELD AND BACKGROUND

The present invention relates to a digital signal processing system including a central processing unit (CPU) and multiple computing elements performing parallel processing and a method of controlling the flow of the parallel processing by the multiple computing elements.

Reference is now made to FIG. 1 which illustrates a conventional system 10 including a CPU 101 and multiple computing elements 109 connected by a crossbar matrix 111. System 10 includes shared memory 103 and a shared direct memory access (DMA) unit 105 for accessing memory 103. Alternatively, conventional system 10 may be configured with a bus and bus arbiter instead of crossbar matrix 111. When CPU 101 runs a task on one of computing elements 109, CPU 101 transfers to computing element 109 a task descriptor including various parameters specifying the task, and then instructs computing element 109 to start processing the task. CPU 101 similarly transfers task descriptors to other computing elements 109 and instructs them execute their respective tasks. CPU 101 then monitors the completion status of each computing element 109 in order to obtain the respective results and prepares further tasks, on a task by task basis, for each computing element 109. Such a control flow performed by CPU 101 includes considerable administrative overhead: moving data, e.g. task descriptors and results, and polling status of tasks. Furthermore, since for a typical application CPU 101 has its own independent tasks for execution based on results generated by one or more of computing elements 109, CPU 101 is often waiting for various tasks to be completed.

When DMA unit 105 is used, the task of moving the descriptors from memory 103 to computing elements 109 would be accomplished by DMA unit 105. However, while overall system performance is marginally improved, CPU 101 is still performing administrative tasks, such as polling status of execution.

In another conventional control flow process, in system 10, DMA unit 105 is multi-channel serving multiple computing elements 109 using interrupt handling. CPU 101 stores tasks in system memory 103. DMA 105 is programmed regarding which tasks relate to which interrupt from the computing elements 109. CPU 101 programs DMA 105 with a linked list of tasks so that DMA 105 writes the upcoming task to computing element 109 upon receiving the appropriate interrupt from the computing element 109 indicating its readiness to execute. In such a system, multiple computing elements 109 are handled sequentially each following the appropriate DMA interrupt.

There is thus a need for, and it would be highly advantageous to have, a system including a CPU and multiple computing elements and method for managing the flow of processing between the CPU and in parallel among multiple computing elements while minimizing management overhead of the CPU.

The term “accessing” is used herein referring to memory and includes reading from and/or storing (i.e. writing) in the memory.

### BRIEF SUMMARY

According to an aspect of the present invention, there is provided a method for controlling parallel process flow in a system including a central processing unit (CPU) attached to and accessing system memory, and multiple computing elements. The computing elements (CEs) each include a computational core, local memory and a local direct memory access (DMA) unit. The local memory and the system memory are accessible by the computational core using the local DMA units. The CPU stores in the system memory multiple task queues in a one-to-one correspondence with the computing elements. Each task queue, which includes multiple task descriptors, specifies a sequence of tasks for execution by the corresponding computing element. Upon programming the computing element with task queue information, the task descriptors of the task queue in system memory are accessed by the local DMA unit which then stores the task descriptors in the local memory of the computing element.

When the tasks of the task queues are executed by the various computing elements, the execution is typically performed in parallel by at least two of the computing elements. The CPU is interrupted respectively by the computing elements only upon fully executing the tasks of the respective task queues. Any results of the execution are preferably stored in the system memory by the local DMA unit of the computing element.

The local memory of a computing element typically has insufficient capacity for storing simultaneously all the task descriptors of the task queue. Access to, and the execution of, the task queue are performed portion-by-portion. When a CE executes one or more tasks of the task queue, the CE then stores the generated execution results in the locations of the local memory which were just previously used to store the task descriptor just executed. When all the tasks within the portion of the task queue brought into the CE have been executed, the local DMA unit then transfers out all the corresponding results to the system memory in an area indicated by the task queue information result queue pointer.

When the task queue is part of a batch of task queues for execution by the computing element, the task queue information preferably includes a pointer to the next queue in the batch. Typically, each of the computing elements have attached control registers. The control registers are loaded with the task queue information regarding the task queue. The task queue information is preferably organized in a data structure which preferably contains: (i) the number of tasks in the task queue, and (ii) a pointer in system memory to where the task descriptors reside. The task queue information preferably also includes: (iii) a results queue pointer which points to a location in system memory to store results of the execution.

According to another aspect of the present invention, there is provided a system including a central processing unit (CPU), a system memory operatively attached to and accessed by the CPU, and computing elements. The computing elements each include a computational core, local memory and a local direct memory access (DMA) unit. The local memory and the system memory are accessible by the computational core using the local DMA units. The CPU stores in the system memory multiple task queues in a one-to-one correspondence with the computing elements. Each task queue includes multiple task descriptors which specify a sequence of tasks for execution by the computing element. Upon programming the computing element with task queue information, and thereby starting execution, the task descriptors of the task queue are accessed in system memory using the local DMA unit of the computing element. The task descriptors of the task queue are stored in local memory of the computing element using the CE's local DMA unit. The tasks of the task queues are executed by the various computing elements such that, typically, at least two of the computing elements process their respective task queues in parallel. The CPU is interrupted by the computing elements only upon fully executing the tasks of their respective task queues. Typically, each of the computing elements have attached control registers. The control registers are loaded with the task queue information regarding the task queue. The task queue information is preferably organized in a data structure which preferably contains: (i) the number of tasks in the task queue, and (ii) a pointer in system memory to where the task descriptors reside. The task queue information preferably also includes: (iii) a results queue pointer which points to a location in system memory to store results of the execution.

According to yet another aspect of the present invention there is provided an image processing system including a central processing unit (CPU), a system memory operatively attached to and accessed by the CPU, and computing elements. The computing elements each include a computational core, local memory and a local direct memory access (DMA) unit. The local memory and the system memory are accessible by the computational core using the local DMA units. The CPU stores in the system memory multiple task queues in a one-to-one correspondence with the computing elements. Each task queue includes multiple task descriptors which specify a sequence of tasks for execution by the computing element. Upon programming the computing element with task queue information of the task queue, thereby starting execution, the task descriptors of the task queue are accessed in system memory using the local DMA unit of the computing element. The task descriptors of the task queue are stored in local memory of the computing element using the local DMA unit of the computing element.

The tasks of the task queue are executed by the computing element and, typically, at least two of the various computing elements process their respective task queues in parallel. The CPU is interrupted by the computing elements only upon fully executing the tasks of their respective task queues.

One computing element is programmed to classify an image portion of one of the image frames as an image of a known object and another computing element is programmed to track the image portion in real time from the previous image frame to the present image frame.

Preferably other (two or more) computing elements are each programmed for one or more of: receiving the image frames and storing the image frames in real-time in the system memory; image generation at reduced resolution of the image frames; real-time stereo processing of the multiple image frames simultaneously with another set of multiple image frames; real-time spatial filtration of at least a portion of one of the image frames; and real-time object classification according to a given set of object templates.

The computing elements are preferably implemented as in an application specific integrated circuit (ASIC).

The foregoing and/or other aspects will become apparent from the following detailed description when considered in conjunction with the accompanying drawing figures.

### BRIEF DESCRIPTION OF THE DRAWINGS

The invention is herein described, by way of example only, with reference to the accompanying drawings, wherein:

FIG. 1 is a system drawing of a conventional system of the prior art;

FIG. 2 is a simplified block diagram of a system according to an embodiment of the present invention;

FIG. 3 is a simplified flow chart of a method for managing parallel execution of tasks, according to an embodiment of the present invention;

FIG. 3A illustrates control registers storing a data structure in accordance with embodiments of the present invention;

FIG. 4 is a simplified flow chart of another method for managing parallel execution of tasks, according to an embodiment of the present invention;

FIG. 4A illustrates the task and result queue data structures as well as the “task queue information” according to the embodiment of the present invention of FIG. 4;

FIG illustrates the task and result queue data structures as well as the “task queue information” according to the embodiment of the present invention of FIG. 3; and

FIG. 6 is a flow diagram of parallel processing in an image processing system, according to an embodiment of the present invention.

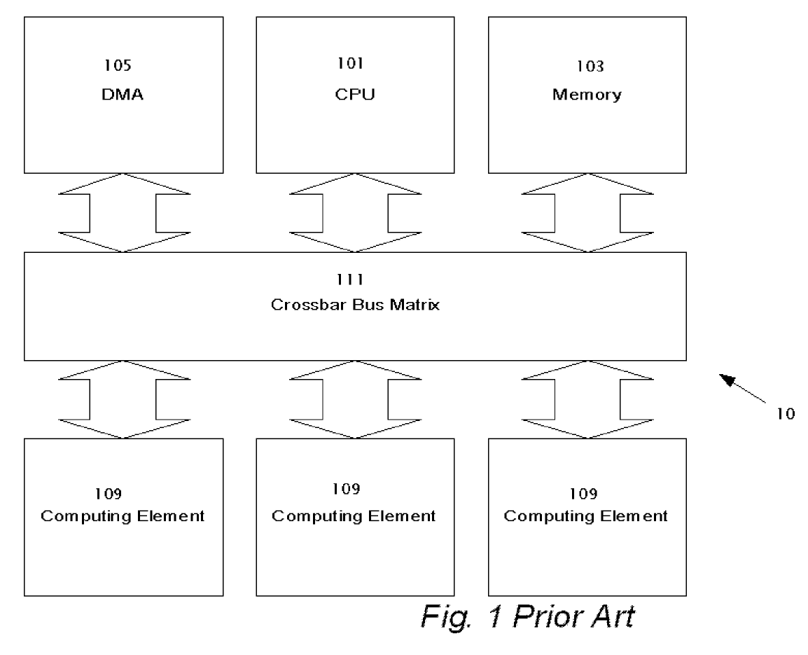

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

It should be noted, that although the discussion herein relates to a system including multiple processors, e.g. CPU and computational elements on a single die or chip, the present invention may, by non-limiting example, alternatively be configured as well using multiple processors on different dies packaged together in a single package or discrete processors mounted on a single printed circuit board.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, a principal intention of the present invention is to improve the performance of a processing system including a CPU and multiple computing elements in which the CPU performs general algorithm flow tasks as well as attendant managerial tasks while the multiple computing elements perform, in parallel, various computation tasks including computation intensive processing. An improvement of performance is achieved by significantly reducing the managerial activity of the CPU—e.g., monitoring, polling, and/or interrupt handling by the CPU and/or DMA.

A preferred embodiment of the present invention referred to herein is intended for image processing of multiple image frames in real time in a vehicle control system. While the discussion herein is directed toward application of the present invention to real time image processing, the principles of the present invention may be readily adapted for use with other digital signal processing systems as well. Other preferred embodiments may be applied by skilled persons in the arts to other signal processing applications such as speech and/or voice recognition, and digital signal processing of communications signals.

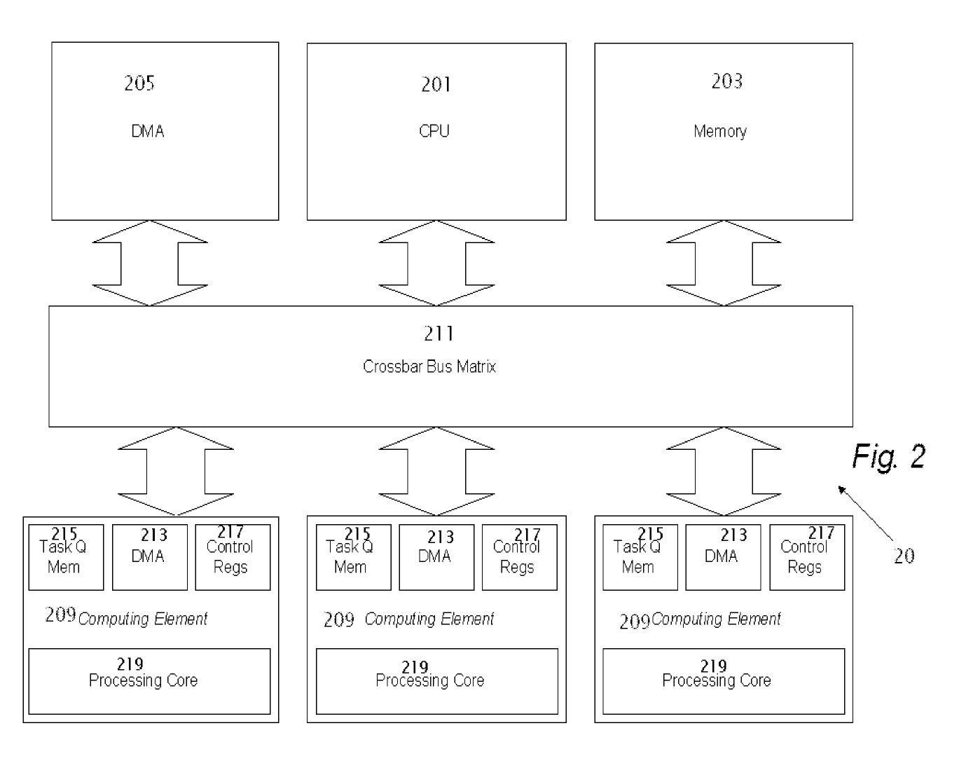

Referring now to the drawings, FIG. 2 shows a simplified block diagram of a system 20, according to an embodiment of the present invention. System 20 includes a CPU 201 attached to a direct memory access unit 205, memory 203 and multiple computational elements 209 through a crossbar bus matrix 211. Within each computing element 209 is a processing computational core 219, a direct memory access (DMA) unit 213, local memory 215 and control registers 217.

Each task that computational core 219 executes has an associated task descriptor which contains the various parameters which define the task, e.g. command and operands. In order to efficiently supply tasks to computing element 209, task queues for each computing element 209 are stored locally in memory 215. The task queue stored in local memory 215, and executed by the computing element 209 is known as the short task queue since it is only a part of the full list of tasks CPU 201 has prepared in system memory 203, for execution by computing element 209. The full list of tasks prepared by CPU 201 for execution by computing element 209 is known herein as the “long queue” which is typically stored in system memory 203.

There are several ways to load local memory 215 with a short queue of tasks for each computing element 209, according to different embodiments of the present invention.

One method, according to an embodiment of the present invention is to have CPU 201 write individually the task descriptors directly into local memory 215 for each of computing elements 209.

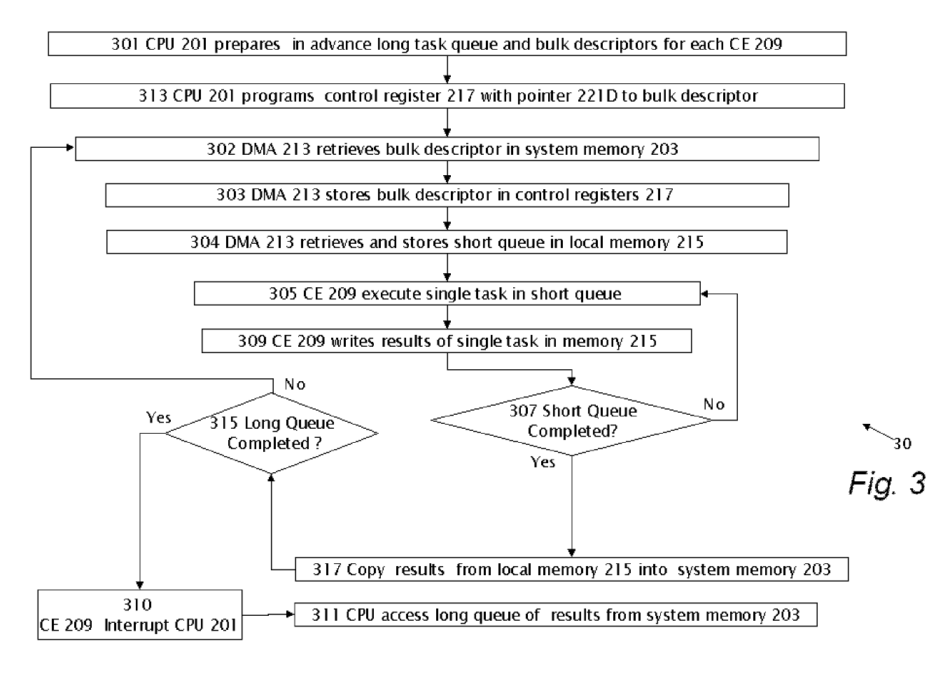

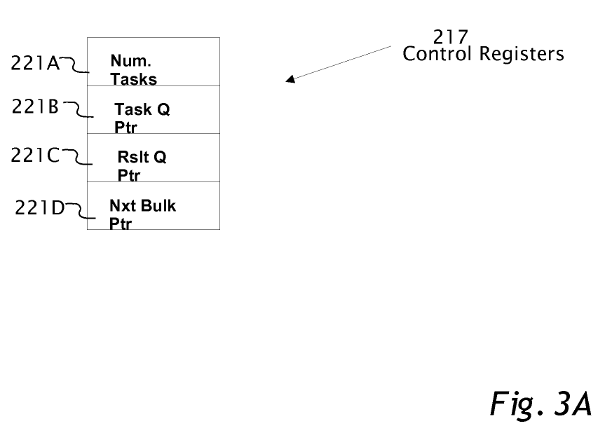

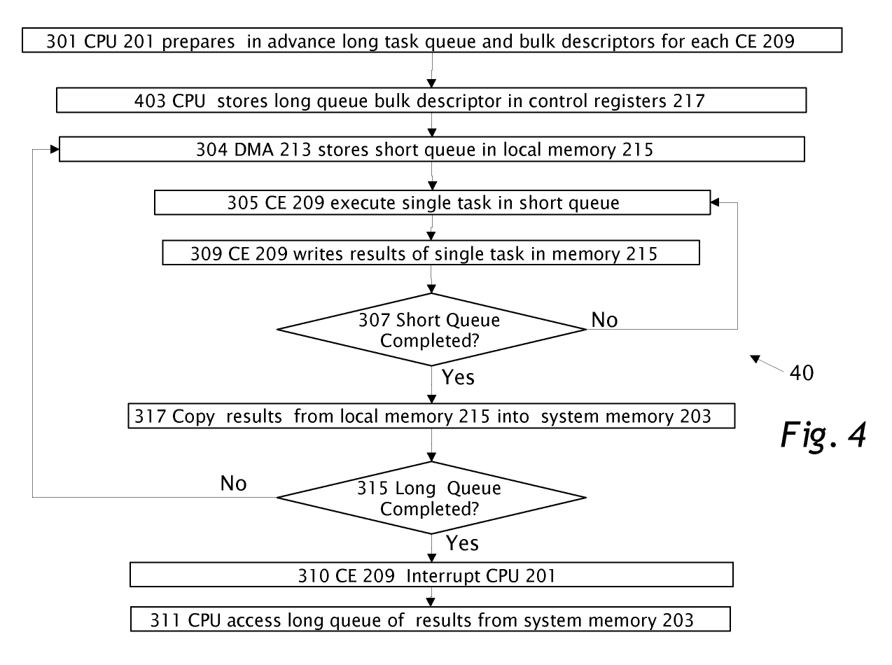

Reference is now made to FIG. 3 which includes a simplified flow chart of a method 30, known herein as “batch mode”, for managing parallel execution of tasks by loading a batch of task descriptors into memory 215, according to an embodiment of the present invention. In step 301, CPU 201, prepares, in advance, several long queues of tasks which need to be executed respectively by each computing element 209. The long queues are stored in system memory 203 along with task queue information referencing the long queues. Computing element 209 handles the long queue of tasks portion-by-portion, each portion being the size of its short queue, which is typically much shorter than the long queue of tasks prepared (step 301) by CPU 201. Reference is now also made to FIG. 3A illustrating control registers 217 storage of a data structure 221, known herein as a “bulk descriptor”, which includes the task queue information referencing the long queues, according to an embodiment of the present invention.

In order to allow for computing element 209 to handle a long queue of tasks though it can only store a limited number of tasks (i.e., the size of its short queue, which is typically much shorter than the long queue of tasks prepared (step 301) by CPU 201, bulk descriptor 221 specifies details about the long queue. Bulk descriptor 221 is used by DMA 213 to retrieve all the tasks in the long queue, by retrieving from memory 203 and storing in memory 215 (multiple times) a number of tasks less than or equal to the length of the short queue.

Bulk descriptor 221 preferably includes the following four fields:
221A: Number of Tasks: indicates the number of tasks in the long queue;
221B: Task queue pointer: contains the address of the first task Descriptor;
221C: Result queue pointer : contains the address of the first Result Descriptor; and
221D: Next Bulk descriptor pointer: a pointer to the next bulk descriptor 221.

Referring back to FIG. 3, CPU 201 then programs (step 313) the control registers 217 of each computing element 209 with pointer 221D to its first bulk descriptor 221. The DMA unit 213 within computing element 209 automatically initiates access to system memory 203, retrieving (step 302) and storing (step 303) the first bulk descriptor 221 in control registers 217. Then, in step 303, based on bulk descriptor 221 values in control registers 217, DMA unit 213 retrieves a short queue of tasks from within the long queue in system memory 203 and stores (step 304) the short queue in the local memory 215. Computing element 209 then executes (step 305) the first task in the short queue. Upon completion (step 305) of a task, computational core 219 writes the results (step 309) of the task in a result descriptor, typically overwriting in local memory 215 the task descriptor of the task just executed. Thus, when computing element 209 is instructed by CPU 201 to begin execution, the local memory 215 is preferably full of a short queue of task descriptors, whereas at the end of execution (decision box 307), local memory 215 is preferably full of a short queue of result descriptors.

When the execution of the short queue is completed (decision block 307), the results are preferably written (step 317) by DMA 213 from local memory 215 to system memory 203. Once the short queue has been completed, computing element 209 checks if the long queue has been completed (decision box 315). If there are still further tasks in the long queue, DMA 213 then retrieves (step 302) the next bulk descriptor 221 and subsequently the related short queue of tasks from system memory 203 is retrieved and stored in local memory (step 304). If the long queue has been fully executed (decision box 315), computing element 209 interrupts (step 310) CPU 201 to indicate that the long queue is fully processed and that the results may be accessed (step 311). CPU 201 accesses (step 311) the results from system memory 203 either directly or through system DMA 205. Alternatively, in the case that CPU 201 programmed computing element 209 to execute only one short queue of tasks, accessing results (step 311) may be performed directly by CPU 201 accessing memory 215.

DMA 213 inputs tasks from memory 203 starting from task queue pointer 221B to store (step 304) a number of tasks, e.g. typically 8 tasks, within the capacity of memory 215) after which computing element 209 starts processing (step 305) the tasks of the retrieved short queue. The process of retrieving (step 302) and storing (step 303) bulk descriptors, retrieving a short queue of tasks from system memory 203 and storing (step 304) the short queue, executing (step 305) tasks, and writing (step 309) the results into memory 215, repeats until all tasks in the long queue have been exhausted. Following completion of the long queue, CPU 201 is notified (step 310), via interrupt, that the bulk processing has been completed.

By employing DMA 213 in each computing element 209, CPU 201 can schedule (step 301) the task queues in advance, and then program each CE's control register 217 bulk descriptor pointer 221D, thus signaling each computing element's 209 local DMA unit 213 to start task retrieval (step 304) and subsequent computing element task execution (step 305). During the time between steps 301 and 310, CPU 201 is free to execute other tasks while the computing elements 209 execute the steps 301 to 310 and supply (step 317) processing results.

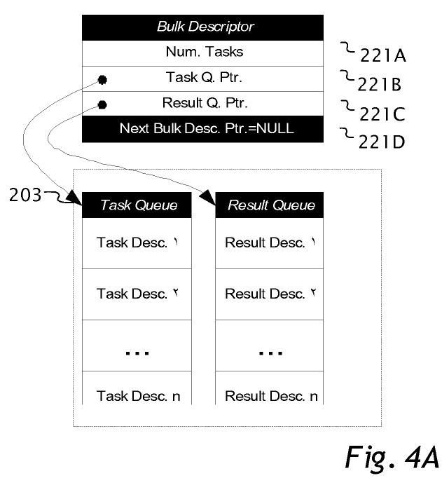

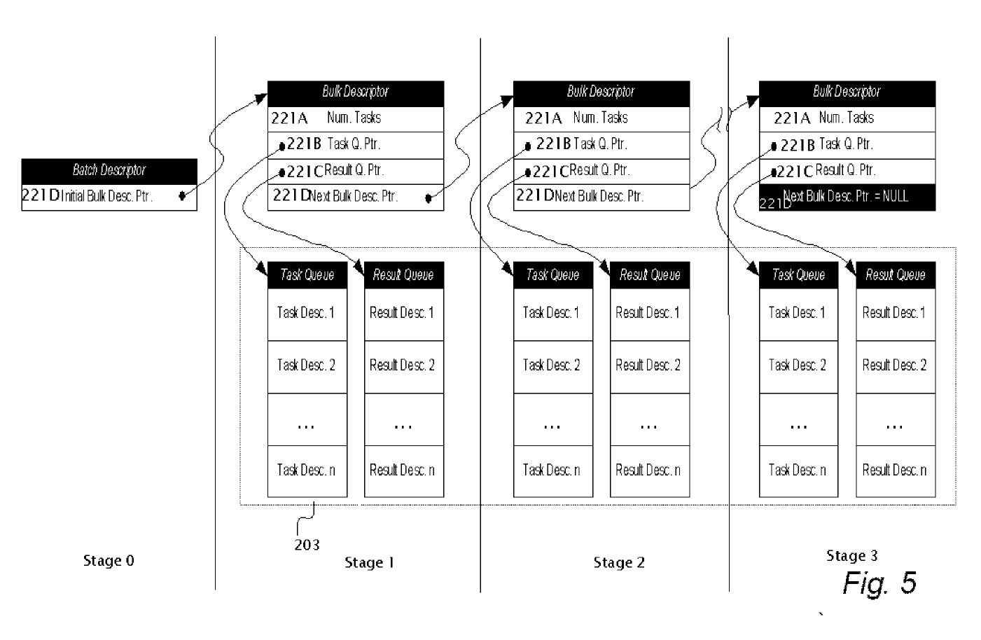

Reference is now made to FIG. 4, a flow diagram of a method 40, according to another embodiment of the present invention. As in method 30, in step 301, CPU 201, prepares, in advance, multiple long queues of tasks which need to be executed respectively by computing elements 209. The long queues are stored in system memory 203 along with task queue information referencing the long queues. CPU 201 stores (step 403) bulk descriptor 221 directly into the control registers 217. Reference is now also made to FIG. 4A, illustrating bulk descriptor 221 programmed into control register 217 with fields 221A-C and next bulk descriptor pointer 221D loaded with a null value. The number of tasks field 221A includes the number of tasks of the long queue. DMA 213 retrieves a short queue of tasks to be stored (step 304) in local memory 215. Computing element 209 then executes (step 305) the first or next task in the short queue. Upon completion (step 305) of a task, computing element 209 writes the results (step 309) of the task in a result descriptor, typically overwriting in local memory 215 the task descriptor of the task just executed. When the execution of the short queue is completed (decision block 307), the results are preferably written (step 317) by DMA 213 from local memory 215 to system memory 203. Computing element 209 checks if the long queue has been completed (decision box 315). If there are still further tasks in the long queue, in step 304, DMA 213 stores the next short queue in local memory 215. If the long queue has been fully executed (decision box 315), the results may be accessed (step 311). CPU 201 accesses (step 311) the results from system memory 203 either directly or through system DMA 205. Alternatively, in the case that CPU 201 programmed computing element 209 to execute only one short queue of tasks, accessing results (step 311) may be performed directly by CPU 201 accessing memory 215.

Reference is now made to FIG. 5 which illustrates the use of the bulk descriptors 221 while performing method 30 according to an embodiment of the present invention. A linked list of bulk descriptors 221 is stored in memory 203. Field 221D is loaded at Stage 0 by CPU 201 with a batch descriptor pointer using the next bulk pointer 221D of standard bulk descriptor 221 pointing in memory 203 to the first (Stage 1) bulk descriptor 221. The first bulk descriptor, i.e. fields 221A-C, is loaded together with the next bulk descriptor pointer 221D at each of stages 1-2. At each of stages 1-3 DMA 213 accesses memory 203 and copies a long queue of task descriptors—in quantities of short queue lengths—into local memory 215. At stage 3, the next bulk descriptor pointer is set to NULL indicating that Stage 3 includes the final long queue of the batch.

The use of batch mode, method 30, allows for task queues to be stored non-contiguously in system memory 203, and hence simplifies memory allocation. The use of batch mode further allows for CPU 201 to initialize execution (step 305) of computing element 209 after preparing the first bulk transfer (Stage 1) of tasks, while CPU 201 then arranges further bulk transfers (stages 2 and 3) in the batch transfer.

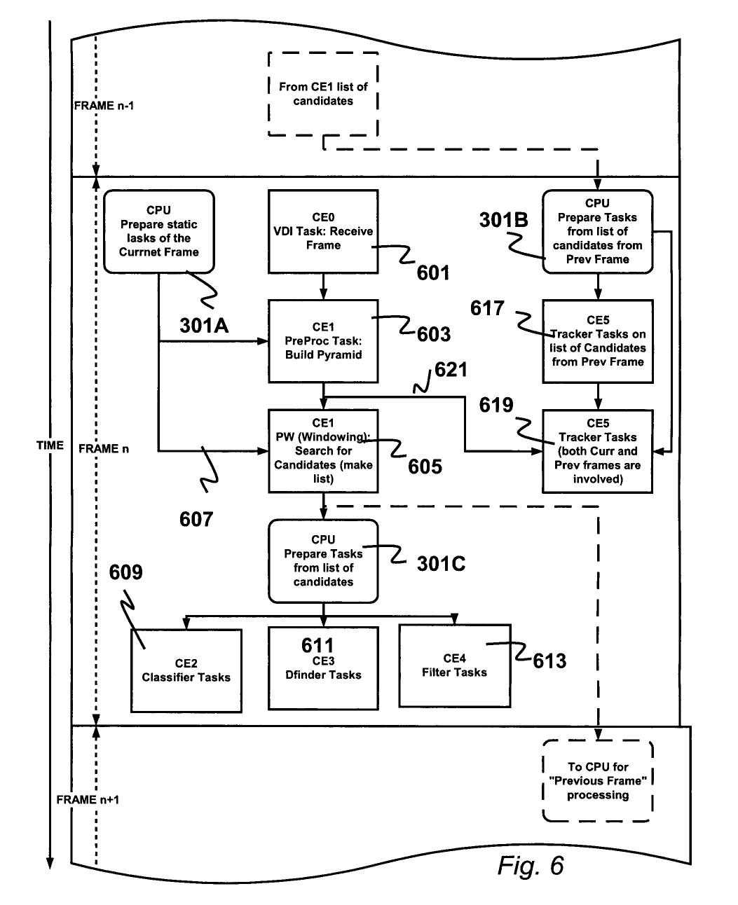

Reference is now made to FIG. 6, which is a flow diagram illustrating parallel processing in an image processing system, according to an embodiment of the present invention. The system of FIG. 6 includes CPU 201 and multiple computing elements 209 CE0-CE5. The system is attached to a digital camera which provides multiple image frames for the processing. Three image frames, Frame (n−1), Frame (n) and Frame (n+1) are shown in the flow diagram of FIG. 6. Control flow is shown (axis on left) from top to bottom where time is divided into three primary blocks indicating processing during Frame (n−1), Frame (n), and Frame (n+1). The complete flow for one frame is shown in Frame (n), the previous and subsequent frames are included due to the interdependencies between frames. Note also the steps of the process are labeled with one of CPU 201 or CE0-CE5 indicating which of computing elements 209 is performing the process step.

Referring to the process steps within Frame (n), an image frame is received by computing element CE0 which typically receives (step 601) Frame (n) from a video interface connected to the camera (not shown) and stores Frame (n) in system memory 203 preferably using system DMA 205. After image Frame (n) is received (step 601), various processing units are programmed with task queues (step 313, FIGS. 3 and 4), some in parallel and some in sequence. In step 301A, CPU 201 prepares tasks related to the current frame. Specifically, computing element CE1 is tasked (step 603) with pre-processing the image frame for instance by preparing an image of smaller size or an image of reduced resolution. Computing element CE1 performs in step 605 a windowing procedure which results in the creation of candidate images. CE1 writes (step 607) into system memory 203 preferably using local DMA 213 the list of candidate images (objects of interest) within image Frame (n). CPU 201 reads the candidate images from system memory 203, (preferably using system DMA 205) and based on the candidate images prepares tasks preferably in parallel (step 301C) for computing elements 209 CE2, CE3 and CE4. Specifically, computing element CE2 is tasked with classifying (step 609) candidate images against known images. An example of classifying includes distinguishing between streetlights and headlights as objects in the environment of a moving vehicle. Computing element CE3 is tasked with stereo processing (step 611) using image Frame (n) and another image frame input from a second camera (not shown in FIG. 6) and CE4 is tasked with performing spatial filtration (step 613) of one or more of the image candidates.

In parallel with the process steps previously described, in step 301B CPU 201 prepares tasks based on a list of candidates from previous Frame (n−1) for computing element CE5 209. Computing element CE5 209 is activated (step 313, FIG. 3) to process (step 617) previous Frame (n−1) and process (step 619) current Frame (n) and previous frame (n−1) together as CE5 performs “tracking” which involves comparisons between images taken from frame to frame over time.

CE5 processes (step 617) image candidates from previous Frame (n−1), in parallel, typically at the same time as step 603 preprocessing by CE1 of the current frame.

Once the current frame pre-processing results (from step 603) are available (indicated to CPU 201 via interrupt (step 310) from CE1), CPU 201 then activates (step 313) the tracking tasks (step 619) of CE5 during which images in the current and previous frames are compared. Note that step 619 is dependent on the results from step 603 and CPU 201 is programmed to wait until the results (step 621) from step 603 are available before signaling (step 313) CE5 to proceed with step 619.

It can be seen from this example in image processing that CPU 201, sets up (step 301) task queues in advance for multiple computing elements 209, and is available to perform other tasks while computing elements 209 are performing intensive multiple computational tasks in parallel. System 20 is typically implemented in hardware as application specific integrated circuits (ASIC) or at least the computing elements 209 are typically implemented in hardware as application specific integrated circuits (ASIC) with the other system components being discrete components on a PCB.

Image processing systems, according to embodiments of the present invention are preferably implemented as a system on a chip (i.e., single ASIC). The architecture is unique and allows for a system scheduler to run in a most efficient manner not possible with standard system architectures including a CPU and other processors sharing a bus and system resources (e.g., DMA, bus arbiter, memory).

While the invention has been described with respect to a limited number of embodiments, it will be appreciated that many variations, modifications and other applications of the invention may be made.

What is claimed is:

1. In a system including:
a central processing unit (CPU) operatively attached to and accessing a system memory; and
a plurality of computing elements, wherein the computing elements each include a computational core, local memory, and a local direct memory access (DMA) unit, wherein the local memory and the system memory are accessible by the computational core using the local DMA unit, a method comprising the steps of:
(a) storing by the CPU in the system memory a plurality of task queues in one-to-one correspondence with the computing elements, wherein each of said task queues includes a plurality of task descriptors which specify a sequence of tasks for execution by the computing elements;
(b) upon programming said computing element with task queue information of said task queue, accessing the task descriptors of said task queue in the system memory;
(c) storing said task descriptors of the task queue in local memory of the computing element; wherein said accessing and said storing are performed using the local DMA unit of the computing element;
(d) executing the tasks of the task queue by the corresponding computing element, wherein said executing of the respective task queues is performed in parallel by at least two of said computing element; and
(e) interrupting respectively the CPU by the computing elements only upon fully executing all the tasks of the respective task queue.

2. The method, according to claim 1, further comprising the step of:
(f) storing results of said executing in the system memory in a plurality of address locations as indicated by said task queue information, wherein said storing of said results is performed by the local DMA unit of the computing element.

3. The method, according to claim 1, wherein the local memory of the computing element has insufficient capacity for storing simultaneously all the task descriptors of the task queue, wherein said accessing, said storing and said executing of said task queue are performed portion-by-portion, and upon generating results of said executing of a portion of said task queue, storing said results of said executing in a plurality of address locations of the local memory which previously stored the task descriptors already executed within said portion of said task queue.

4. The method, according to claim 1, wherein the task queue is part of a batch of task queues for execution by the computing element, said task queue information further including a pointer to the next task queue in the batch.

5. The method, according to claim 1, further comprising the steps of, prior to said accessing:
(f) providing each of the computing elements with a plurality of control registers;
(g) loading said control registers with said task queue information including: (i) the number of tasks in the task queue, and (ii) a pointer in system memory to where said task descriptors reside.

6. The method, according to claim 5, wherein said task queue information further includes: (iii) a results queue pointer which points to a location in the system memory for storing results of said executing.

7. A system comprising:
(a) a central processing unit (CPU);
(b) a system memory operatively attached to and accessed by said CPU; and
(c) a plurality of computing elements, wherein said computing elements each include a computational core, local memory, and a local direct memory access (DMA) unit, wherein said local memory and said system memory are accessible by said computational core using said local DMA units,
wherein said CPU stores in said system memory a plurality of task queues in one-to-one correspondence with said computing elements, wherein each task queue includes a plurality of task descriptors which specify a sequence of tasks for execution by said computing element,
wherein upon programming said computing element with task queue information of said task queue, said task descriptors of said task queue are accessed in system memory using said local DMA unit of said computing element,
wherein said task descriptors of said task queue are stored in local memory of said computing element using said local DMA unit of said computing element,
wherein said tasks of said task queue are executed by said computing element and at least two of said computing elements process respective task queues in parallel, and
wherein said CPU is interrupted by said computing elements only upon fully executing said tasks of said respective task queue.

8. The system, according to claim 7, further comprising:
(d) a plurality of control registers, wherein said control registers are loaded with said task queue information including: (i) the number of tasks in the task queue; and (ii) a pointer in system memory to where said task descriptors reside.

9. The system, according to claim 8, wherein said task queue information further includes: (iii) a results queue pointer which points to a location in the system memory for storing results of said execution.

10. An image processing system for processing in real time multiple image frames, the system comprising:
(a) a central processing unit (CPU);
(b) a system memory operatively attached to and accessed by said CPU; and
(c) a plurality of computing elements, wherein said computing elements each include a computational core, local memory, and a local direct memory access (DMA) unit, wherein said local memory and said system memory are accessible by said computational core using said local DMA unit,
wherein said CPU stores in said system memory a plurality of task queues in one-to-one correspondence with said computing elements, wherein each task queue includes a plurality of task descriptors which specify a sequence of tasks for execution by said computing element,
wherein upon programming said computing element with task queue information of said task queue, said task descriptors of said task queue are accessed in system memory using said local DMA unit of said computing element,
wherein said task descriptors of said task queue are stored in local memory of said computing element using said local DMA unit of said computing element,
wherein said tasks of said task queue are executed by said computing element and at least two of said computational cores process respective task queues in parallel,
wherein said CPU is interrupted by said computing elements only upon fully executing said tasks of said respective task queue,
wherein at least one of the computing elements is programmed to classify an image portion of one of the image frames as an image of a known object, and
wherein another of the computing elements is programmed to track said image portion in real time from the previous image frame to the present. image frame.

11. The system, according to claim 10, wherein yet another of the computing elements is programmed for receiving the image frames and storing the image frames in real-time in the system memory.

12. The system, according to claim 10, wherein yet another of the computing elements is programmed for real-time reduced resolution image generation.

13. The system, according to claim 10, wherein yet another of the computing elements is programmed for real-time stereo processing of the multiple image frames simultaneously with another set of multiple image frames.

14. The system, according to claim 10, wherein yet another of the computing elements is programmed for real-time spatial filtration of at least a portion of one of the image frames.

15. The system, according to claim 10, wherein said computing elements are implemented as application specific integrated circuits (ASIC).
